(19) United States
(12) Patent Application Publication
(10) Pub. No.: US 2023/0264148 A1
(43) Pub. Date: Aug. 24, 2023

(54) DISSOCIATION AND RECOMBINATION CATALYST LAYERS FOR REVERSE AND FORWARD-BIAS BIPOLAR MEMBRANES

(71) Applicant: University of Oregon, Eugene, OR (US)

(72) Inventors: Shannon Boettcher, Eugene, OR (US); Lihaokun Chen, Eugene, OR (US); James Mitchell, Eugene, OR (US); Sayantan Sasmal, Eugene, OR (US); Nicole Sagui, Eugene, OR (US); Prasad Sarma, Eugene, OR (US)

(73) Assignee: University of Oregon, Eugene, OR (US)

(21) Appl. No.: 18/112,868

(22) Filed: Feb. 22, 2023

Related U.S. Application Data
(60) Provisional application No. 63/313,594, filed on Feb. 24, 2022.

(51) Int. Cl. B01D 61/44; B01D 69/02; C25B 11/052; C25B 11/077; C25B 11/091; C25B 13/02; C25B 1/04

(52) U.S. Cl. CPC B01D 61/445; B01D 69/02; C25B 11/052; C25B 11/077; C25B 11/091; C25B 13/02; C25B 1/04; B01D 2325/10

(57) ABSTRACT

A bipolar membrane comprising a first member comprising at least one anion exchange material; a second member comprising at least one cation exchange material, wherein the first member and the second member together form an interface junction; and disposed within the interface junction a solitary layer comprising a composite water dissociation catalyst or a composite water recombination catalyst.

### CROSS-REFERENCE TO RELATED APPLICATION

This application claims the benefit of the earlier filing date of U.S. Provisional Application No. 63/313,594, filed on Feb. 24, 2022, which is incorporated herein by reference in its entirety.

### ACKNOWLEDGMENT OF GOVERNMENT SUPPORT

This invention was made with government support under Grant No. N00014-20-1-2517 awarded by the Office of Naval Research. The government has certain rights in the invention.

### BACKGROUND

Catalyzing heterolytic water dissociation (WD), H₂O→H⁺+OH⁻, is practically important for accelerating electrocatalytic reactions that consume water and for fabricating bipolar-membrane (BPM) devices that couple different pH environments into a single electrochemical process. Slow water dissociation kinetics have led to bipolar membranes with poor electrochemical performance unsuitable for energy conversion technologies such as water electrolyzers. Catalyzing water recombination (WR), H⁺+OH⁻→H₂O, is practically important for fabricating BPM devices such as fuel cells and carbon-dioxide electrolyzers.

### SUMMARY

Disclosed herein in one embodiment is a bipolar membrane comprising a first member comprising at least one anion exchange material; a second member comprising at least one cation exchange material, wherein the first member and the second member together form an interface junction; and disposed within the interface junction only a solitary (single) layer comprising a composite water dissociation catalyst or a composite water recombination catalyst.

Also disclosed herein is a method comprising hydrating the bipolar membrane, and applying a reverse electrochemical bias to the bipolar membrane thereby dissociating water at the bipolar membrane interface junction.

Further disclosed herein is a method comprising introducing H⁺ into the at least one cation exchange material of the bipolar membrane, introducing OH⁻ into the at least one anion exchange material, and applying a forward electrochemical bias to the bipolar membrane thereby recombining water at the bipolar membrane interface junction.

The foregoing will become more apparent from the following detailed description, which proceeds with reference to the accompanying figures.

### BRIEF DESCRIPTION OF THE DRAWINGS

FIG. 1: Table showing the materials tested for water dissociation and water recombination catalysis in the bipolar membrane along with the abbreviations used throughout the figures and specification.

FIGS. 2A-2D: Nanoparticle catalysts used in forward and reverse bias BPM reactions of water dissociation and H⁺/OH⁻ recombination, respectively. (FIG. 2A) Schematic of the reverse bias bipolar membrane and location of water dissociation catalyst in the center of the junction (i.e., the interface junction) between the anion-exchange layer and cation-exchange layer. (FIG. 2B) Exemplar data show the performance of various component films for water dissociation in a bipolar membrane electrolyzer as a function of thickness. The thickness of the WD catalyst film is controlled for optimal performance by balancing the number of water dissociation catalyst sites against the electric field strength in the BPM junction. (FIG. 2C) Schematic of bipolar membrane operating in forward bias where H⁺ and OH⁻ are recombined in the junction (i.e., the interface junction). (FIG. 2D) Exemplar data showing how layers of oxide nanoparticles catalyze the H⁺/OH⁻ recombination reaction in the bipolar membrane. In this example the cell is driving the hydrogen oxidation reaction at the acidic anode (next to CEM) and the hydrogen evolution reaction at the alkaline cathode (next to the AEM), but the specific anode and cathode reactions can be changed as desired.

FIGS. 3A-3B: Proposed mechanism for voltage-driven catalyzed water dissociation. (FIG. 3A) The “external” electric field originates from the unbalanced fixed charges in the AEL and CEL. The local electric field (shown in green arrows) originates from the protonation and deprotonation of the nanoparticle surface hydroxyls, and further modulated by electronic polarization inside the nanoparticles, as well as the external electric field. The local electric field induces the water molecules to orient and facilitate water dissociation and proton transfer. M, M′, and M″ denote different sites on the catalyst surface. (FIG. 3B) Electric-potential (ϕ) profiles of pristine BPMs and catalyzed BPMs. The hydrogen bond between water molecules is also shown for comparison.

FIG. 4: Example of composite films with approximately optimized mass loading, in this case consisting of oxide particles with a distribution of size (10-30 nm).

FIGS. 5A and 5B: Composite nanoparticles consisting of mixtures of carbon and anatase/rutile titanium dioxide nanoparticles. The performance of thicker water dissociation catalyst films can be increased substantially by the controlled addition of carbon (here acetylene carbon black, ACB).

FIGS. 6A-6B: (FIG. 6A) Nanoparticle catalysts with controlled surface chemistry for water dissociation and recombination. (FIG. 6B) The current voltage data shows how SiO₂ nanoparticles modified with carboxyethylsilanetriol can be used in bipolar membrane electrolyzers with low voltages at high currents, indicating very low water dissociation voltage losses.

FIGS. 7A and 7B: Composite nanoparticle water dissociation catalysts consisting of Ti metal and TiO₂. For the same size particles and mass loading in the bipolar membrane electrolyzer, the composite catalysts have far superior performance.

FIG. 8: Nanoparticle catalysts with controlled surface chemistry for water dissociation and recombination made by chemically oxidizing the surface of, in this example, TiB₂ nanoparticles to lower the electrolysis and water dissociation voltage loss at very high current density of 1 A cm⁻². The same strategy can be applied to Sn and Ti metal nanoparticles, or any other nanoparticle where surface oxidation controls the number, density, or acid/base properties of surface functional groups like hydroxyl or carboxylates.

FIGS. 9A-9F: Core-shell composite nanoparticle water dissociation catalysts consisting of metal or metal oxide cores and TiO₂ or HfO₂ shells deposited via atomic-layer deposition. Surface oxide layers enhance water dissociation rates and are supported on a metallic core that further enhances water dissociation activity by screening and focusing the electric field within the interface junction. Thin WD catalyst coated on highly conducting (or metallic) cores can incorporate both electric-field enhancements and catalytic WD pathways to enhance performance in BPM electrolyzers. (FIG. 9A) TiO₂ coated and (FIG. 9B) HfO₂ coated core-shell nanoparticles containing various core materials (silicon, tin, ZrO₂, and Indium-Tin Oxide nanoparticles) as WD catalysts. TEM images of TiO₂ coated on (FIG. 9C) silicon, (FIG. 9D) tin, (FIG. 9E) ZrO₂ and (FIG. 9F) indium-tin oxide nanoparticles.

FIGS. 10A-10B: (FIG. 10A) Scatter plot was developed to represent the interrelation of variables that determine the water dissociation performance (FIG. 10B) The features correlated with 0.05 significances are marked with a star in the Pearson correlation coefficient plot. The key parameters are controlling the electrical conductivity and the hydroxyl surface concentration.

FIGS. 11A-11B: (FIG. 11A) Experimental water dissociation overpotential at 500 mA/cm2 (η_{wd}) versus those predicted from the materials parameters and model relation. The model analytical expression is given in the inset of FIG. 11A. Here k is the electronic conductivity (s·m⁻¹) and C is the surface-normalized OH concentration (mol·m⁻²). (FIG. 11B) Polarization curve of BPMs with oxide nanoparticle film catalysts with the optimized SnO₂ particle films showing exceptional J−η_{wd} response. The optimized SnO₂ particle films have distribution of particles sizes ˜2-20 nm in dimension,

FIG. 12: Example embodiment of a bipolar membrane with a solitary catalyst layer used in an electrodialysis application where electrolytes are freely flowed through a flow channel adjacent to the BPM for the electrosynthesis of acid and base.

### DETAILED DESCRIPTION

As used herein, the term “ionomer” generally refers to a polymer or other material that conducts ions. More precisely, the ionomer refers to a material that includes repeat units of at least a fraction of ionized units. As used herein, the term “polyelectrolyte” generally refers to a type of ionomer, and particularly a material whose repeating units bear an electrolyte group, which will dissociate when the polymer is exposed to aqueous solutions (such as water), making the polymer charged. The ionomers and polyelectrolytes may be generally referred to as “charged polymers” or “charged materials”. As used herein, polyelectrolyte, ionomer, and charged polymer can be used interchangeably.

“Nanoparticle”, as used herein, unless otherwise specified, generally refers to a particle of a relatively small size, but not necessarily in the nanometer size range. In certain embodiments, nanoparticle specifically refers to particles having a diameter from 1 nm to 1 micron, or 1 to 1000 nm, preferably from 3 to 100 nm. As used herein, the nanoparticle encompasses nanospheres, nanocapsules, nanoparticles, or nanorods, unless specified otherwise. A nanoparticle may be of composite construction and is not necessarily a pure substance; it may be spherical or any other shape. The particle diameters reported are typically averages estimated from electron microscopy images or gas absorption surface area measurements.

### Overview

Water is arguably the most-important molecule to humanity due to its ubiquitous role in biological, industrial, and environmental processes. Heterolytic water dissociation (WD), H₂O→H⁺+OH⁻, and the opposite reaction of proton/hydroxide (water) recombination, H⁺+OH⁻→H₂O, are the simplest reactions involving water and critical elementary steps in many chemical and (electro)catalytic processes. Improving the activity of water dissociation and recombination catalysts and developing a basic understanding of their function, particularly under conditions relevant to aqueous (electro)catalytic applications, is thus of practical importance.

One electrochemical system that can be used to drive water dissociation and recombination is the bipolar membrane (BPM). A BPM is an ion exchange membrane having a first member comprising at least one anion exchange material adjacent to a second member comprising at least one cation exchange material to form a junction. The anion exchange material may be in the form of an organic or inorganic anion exchange membrane or layer. The cation exchange member may be in the form of an organic or inorganic cation exchange membrane or layer. As used herein, the term “AEM” denotes an anion-exchange membrane generally made of ionomers and designed to conduct anions, and the term “CEM” denotes a cation exchange membrane generally made of ionomers and designed to conduct cations. A CEM has fixed anionic groups and mobile cations. An AEM has fixed cationic groups and mobile anions.

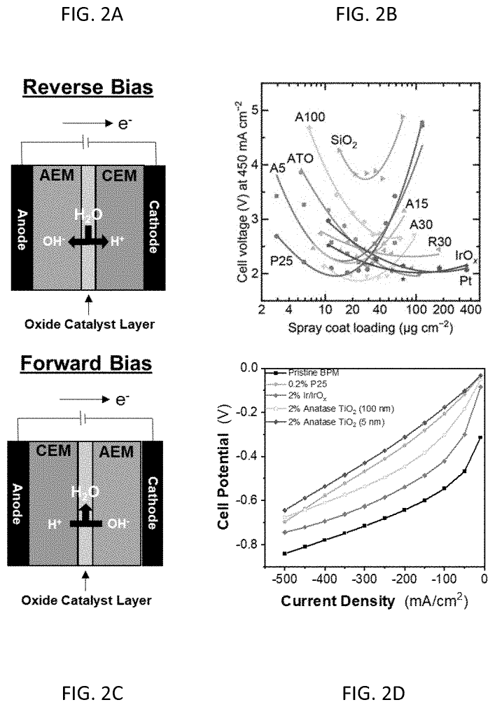

When sufficient electrochemical bias of the appropriate sign, i.e., a reverse bias, is applied across a hydrated BPM, water in the BPM junction is dissociated. The generated H⁺ and OH⁻ are separated with the H⁺ driven through the CEM with [H⁺]˜1 M and the OH⁻ through the AEM with [OH⁻]˜1 M (see FIG. 2A). The high ionic conductivities of the AEM and the CEM ensure that only a comparatively small part of the applied electrochemical potential difference (free energy input) is needed for ionic transport in the membranes. Traditionally, most of the free energy input is consumed in dissociating water inside the junction. To lower the wasted free energy for WD, i.e. the WD overpotential (η_{wd}), WD catalysts are needed inside the interface junction. If the opposite sign of electrochemical bias is applied, i.e. forward bias, protons and hydroxides are driven to the center of the junction and caused to recombine. To make this recombination reaction proceed without substantial voltage loss, we discover that it must be, and can be, catalyzed like the water dissociation reaction.

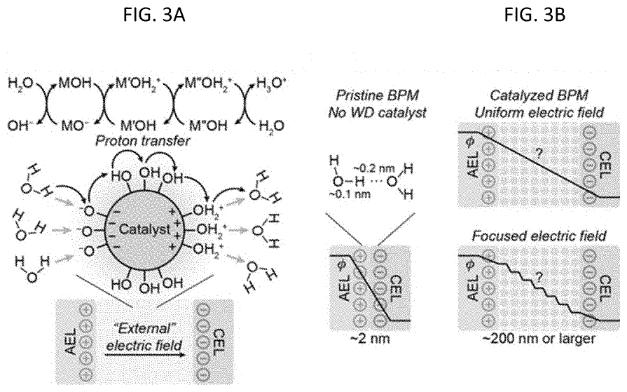

Disclosed herein is a new model for the voltage-driven catalyzed water dissociation reaction (FIGS. 3A-3B), where the external electric fields, interfacial electrostatic effects, and surface interactions of the solitary composite catalyst layers disclosed herein combine to dramatically lower the free energy losses associated with water dissociation. The acid/base properties of the composite catalyst layers serve as a “sink” or “source” of protons which facilitates transport on the nanoparticle surfaces. Local equilibrium between the water dissociation catalyst and liquid water further leads to interfacial electrostatic effects in the form of a double-layer electric field whenever the local pH is not at the point of zero charge (PZC) of the nanoparticle. The strength of this local interfacial field is likely important for proton transfer reactions between the surface of the catalyst particle and the water, modulating the interfacial water structure and properties. The external electric field, originating from uncompensated fixed charges in the AEL and CEL, further affects the water dissociation activity. If the catalyst nanoparticle has high electronic conductivity (e.g., IrOₓ, Sb:SnO₂, etc.), the electrons inside the nanoparticle will redistribute to screen the electric field and the nanoparticle will be polarized. WD catalysts with a high dielectric constant (e.g., TiO₂), will similarly screen the electric field inside the particle and increase the electric field outside the particle. These electric field enhancements will further promote reorientation of the interfacial water at the catalyst surface, enhancing proton transfer rates and thus water dissociation.

The BPM interface junction may be planar as shown in FIG. 2A. Alternatively, the BPM interface junction may be a three-dimensional junction as described, for example, in US 2019/0134570A1 and WO 2017/205458A1.

At electrochemical equilibrium (no current flow) an electrostatic potential develops across the BPM that compensates the chemical potential difference between the AEM and CEM, i.e. the different H⁺ activities between the AEM and CEM. Two pH-independent reference electrodes (e.g. Ag/AgCl) are used to measure this electrostatic potential difference, which is ideally 0.83 V at 25° C. when the membranes are ˜1 M in OH⁻ and H⁺. When current is passed through the system (for example by driving faradaic reactions on two electrodes separate from the reference electrodes, e.g. see BPM electrolyzer), the electrostatic potential across the bipolar membrane changes, because a driving force is needed to dissociate water and separate the incipient H⁺ and OH⁻ in the AEM/CEM junction region or, for forward bias, increase the concentration of H⁺ and OH⁻ in the AEM/CEM junction region to cause their recombination and formation of H₂O. This measured electrostatic potential change is either the water dissociation overpotential (η_{wd}) or water recombination (η_{wr}) required to drive the WD reaction maintaining the constant [H⁺] and [OH⁻] within the CEM and AEM, respectively, at steady state.

Commercial and research BPMs show slow water dissociation and recombination kinetics with substantial overpotentials (>100 mV) even at moderate current densities of ˜20 mA cm⁻². Because of the large water dissociation and recombination overpotentials, BPMs cannot yet be used in applications where low overpotentials at high current densities of 0.5-2 A cm⁻² are required, such as water electrolysis (2H₂O→2H₂+O₂), CO₂ electrolyzers where BPMs prevent dissolved (bi)carbonate crossover, or (regenerative) fuel cells where BPMs facilitate the use of earth-abundant electrocatalysts.

### Composite Catalysts

The structures and methods disclosed herein are applicable to any electrode or chemical process where controlling the reactivity of water to dissociate and provide H⁺/OH⁻, or recombine H⁺/OH⁻, is important. Specifically, we have discovered new mechanisms to improve the performance of bipolar membranes by using composite water dissociation or recombination catalysts where only a solitary catalyst layer is disposed within the interface junction. In other words, the BPM does not include more than one catalyst layer disposed within the interface junction. The single catalyst layer is of uniform average bulk composition but is composed of a composite. In particular, described herein are single catalyst layer interface junctions of macroscopically uniform nanoparticle composites that are engineered to yield exceptional water dissociation or water recombination performance (FIGS. 2A-2B). While the catalysts are typically in the form of nanoparticles, other morphologies are also possible, such as microparticles. In some instances two or more different nanoparticles are homogeneously dispersed in the composition, while in other instances each nanoparticle is composed of two or more components with different composition or structure. Disclosed herein are several composite catalyst embodiments.

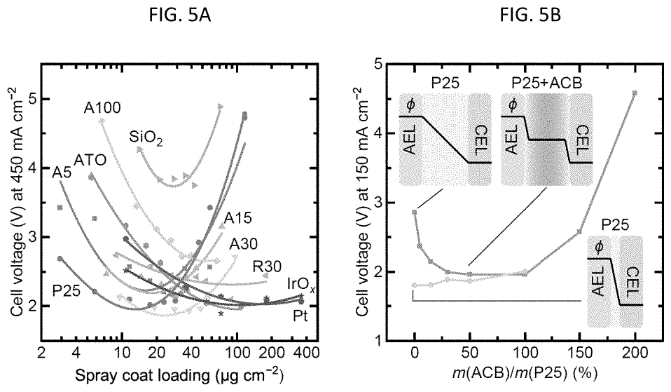

In one embodiment, the composite catalyst includes a mixture or combination of at least two different nanoparticle constituents where the difference is in nanoparticle chemical composition or crystal structure. For example, a first group of nanoparticles may have a first chemical structure and a second group of nanoparticles may have a second chemical structure that is different than the first chemical structure. Examples are mixtures of two or more distinct chemical compositions of nanoparticles, typically of oxide nanoparticles or of oxide nanoparticles combined with electrically conducting nanoparticles. One example of such a high-performance composite nanoparticle water-dissociation layer is that composed of titanium dioxide nanoparticles mixed with conducting carbon nanoparticles that enhance performance of water dissociation by controlling the electric field screen effects within the BPM junction as shown in FIGS. 5A-5B. The relative amounts of titanium dioxide and carbon range from a 10:1 to a 1:10 weight:weight ratio, with typically best performance found for 50 wt % carbon (ACB) with TiO₂ (P25). A second example is a mixture of metallic (e.g. Ti or Sn) and semiconducting (e.g. TiO₂ or SnO₂) particles together used in a single layer to catalyze water dissociation. The relative amounts of titanium dioxide and titanium metal, or tin dioxide and tin metal, range from a 10:1 to a 1:10 weight:weight ratio, with typically best performance found for 50 wt % oxide and wt % metal. A third example is film of SnO₂ nanoparticles where the surface of the particles has been synthesized in way where there are a large number of hydroxyl, absorbed water, or other proton-containing species.

The composite water dissociation or recombination catalysts can be further engineered by controlling the chemical composition of the constituent nanoparticles through chemical doping. For example, simple and scalable sol-gel or other well-established hydrothermal synthesis chemistry can be modified to add other cations to TiO₂ or SnO₂ nanoparticle water dissociation catalysts to tune the surface acidic/basic sites (typically associated with oxygen containing surface groups that can accept or donate protons), and further tune water dissociation performance simultaneously at the acidic CEL and basic AEL within the BPM. In one example, Ni can be doped into the TiO₂ or SnO₂ to accelerate water dissociation when the catalyst is in contact with the alkaline side of the BPM. In another example of a catalyst, TiO₂ or SnO₂ can be mixed with other simple, stable nanoparticles (e.g., SnO₂, SiO₂) with high surface areas. The mixed WD catalyst can thus be engineered for chemical stability and performance across the range of pH conditions in the CEL-AEL junction that comprises the bipolar membrane.

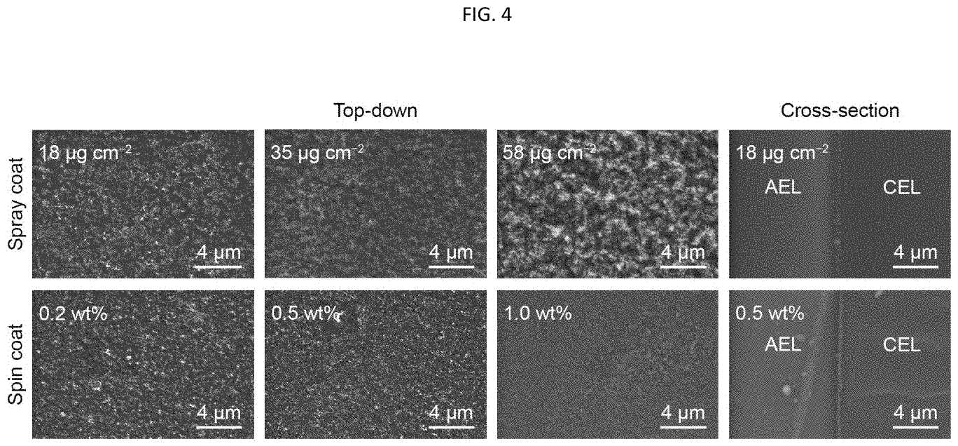

In another embodiment, the composite catalyst includes a mixture or combination of at least two different nanoparticle constituents where the difference is in nanoparticle crystal structure, nanoparticle size, nanoparticle shape and/or nanoparticle density. For example, a first group of nanoparticles may have a first defined crystal structure and a second group of nanoparticles may have a second defined crystal structure that is different than the first defined crystal structure. Examples of composites of nanoparticles include mixtures of the same chemical composition nanoparticles but different crystal structures, such as mixtures of crystalline titanium dioxide nanoparticles with the anatase, rutile and/or brookite structure. In another example, the composite may comprise nanoparticle assemblies with varying shape (typically irregular, with different facets exposed, but nanoparticles particles with controlled crystalline facets, for example [100] or [111] terminated crystallites, can also be used as a component of a composite catalyst layer). In another example, a first group of nanoparticles having a first nanoparticle size and a second group of nanoparticles having a second nanoparticle size that is different than the first nanoparticle size. The first size range can be from 1-10 nm and the second size range from 10-100 nm in diameter. In one illustrative example, the composites are mixtures of nanoparticles with different sizes, for example mixtures of 10 nm and 30 nm diameter oxide nanoparticles or mixtures containing a distribution of nanoparticle sizes between a certain size range that are controlled to enhance water dissociation performance (see FIG. 4). In another example, a first group of nanoparticles having a first nanoparticle density and a second group of nanoparticles having a second nanoparticle density that is different than the first nanoparticle density. For example, the first nanoparticle tapped density between 0.1 to 1 g/cm³ while the second nanoparticle tapped density may be between 1 and 10 g/cm³. In certain embodiments, the nanoparticles are in an amorphous phase, while in others they are in a crystalline phase.

In a further embodiment, the composite for the single layer includes a mixture or combination of at least two different nanoparticle constituents where the difference is in nanoparticle surface chemistry (chemical or other surface treatments to improve performance of water dissociation or recombination and mechanical and chemical durability). For example, a first group of nanoparticles may have a first surface chemistry (such as hydroxyl termination) and a second group of nanoparticles may have a second surface chemistry that is different than the first surface chemistry (such as carbonyl termination).

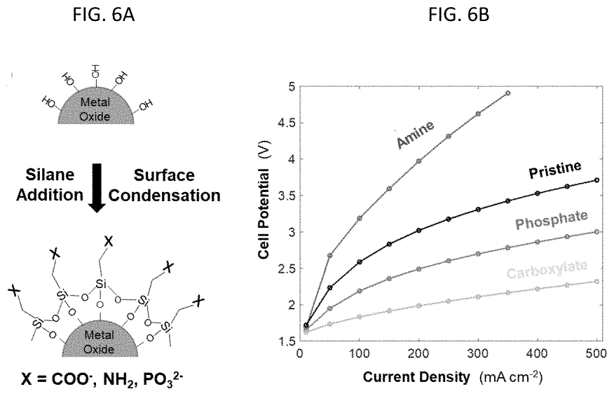

For example, intentional surface chemistry can be used to further control the water dissociation and recombination activity of catalysts for the application of bipolar membranes or other applications, such as electrocatalysis or electrode engineering, where controlling the reactivity of water is important. For example, we have discovered the ability to control and improve the water dissociation activity of composite catalyst layers by molecularly modifying the surface of catalyst particles (FIG. 6A). Surface functionalization of nanoparticles can modify the surface chemistry via linkage of various functional groups (phosphates, carboxylates, amines, etc.) to the catalyst surfaces. Surface linkage is achieved by covalent attachment with simple reactants and reactions, for example, but not limited to, through silane functionality or other robust chemically controlled linkages. Functionalization can be used to control the surface catalyst site by tuning the hydrophilicity, charge, surface proton absorption site density, and/or pKa of the nanoparticle surface. Either a single surface modifying ligand, or a mixture of ligands can be used to optimize performance. Modifying the surface can tune the properties of composite catalyst layers to systematically enhance or suppress the water dissociation activity. In addition to bipolar membranes, tuning the water dissociation activity via surface functionalization of nanoparticles could be utilized in any process where water dissociation may play a role in activity (e.g.—electrocatalytic CO₂ and NH₃ reduction).

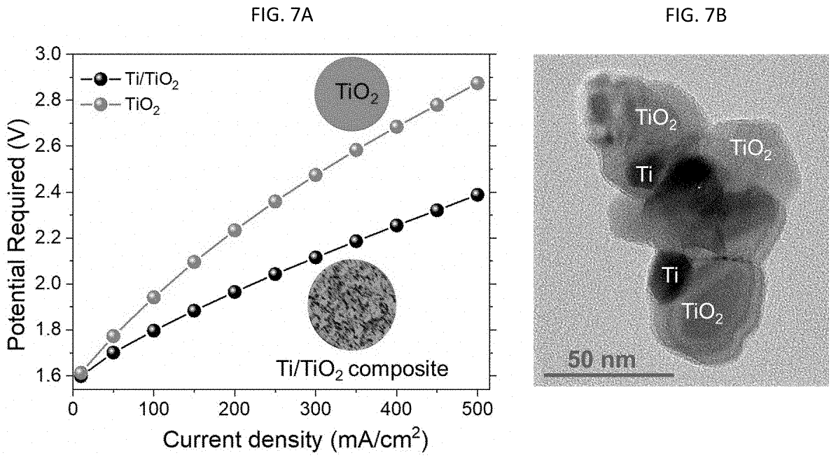

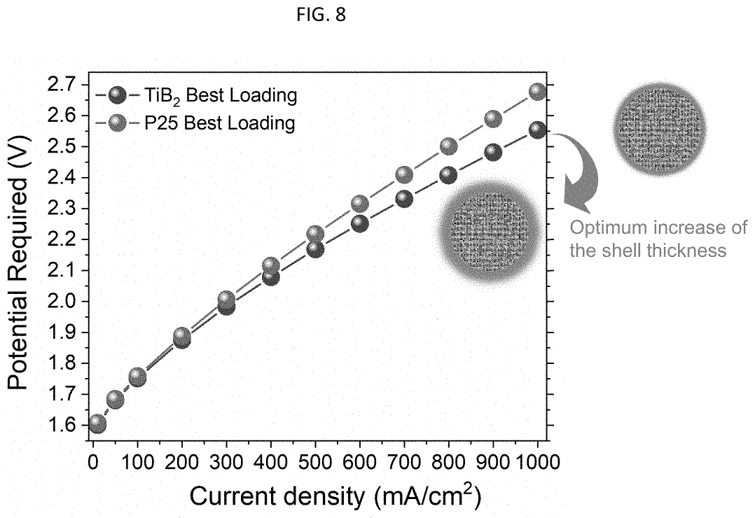

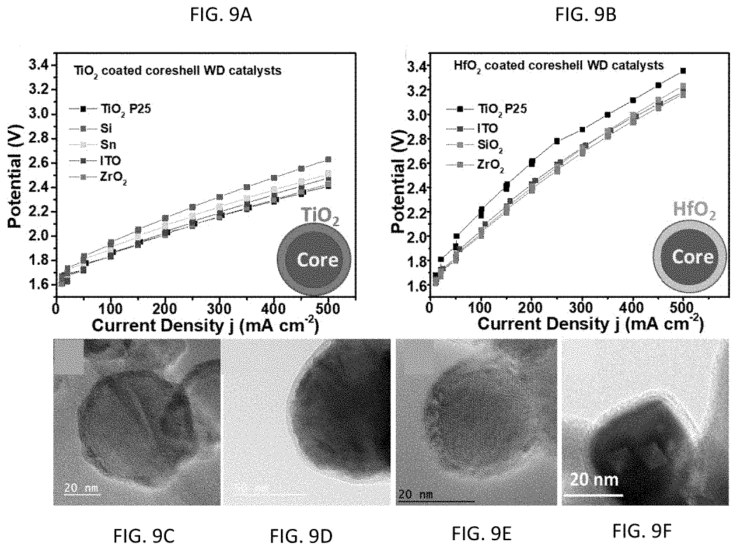

In addition, or in the alternative to, molecular functionalization, chemical treatments can be used to control the surface of the nanoparticle water dissociation or water recombination catalyst independent of the interior chemical/crystalline properties of the nanoparticle (FIGS. 7A, 7B, 8). In one example, the surface of Ti and Sn metal nanoparticles has been oxidized forming core-shell particles where the surface oxide layer enhances water dissociation rates and is supported on a metallic core that screens and focuses the electric field within the bipolar membrane junction for enhanced water dissociation activity. Atomic layer deposition is an additional method of forming core-shell particles to alter the water dissociation activity of the solitary composite catalyst layer. For example, thin oxide layers (e.g. TiO₂ or HfO₂) can be deposited onto various core nanoparticles to modulate the water dissociation activity and lower the free energy losses associated with a BPM water electrolyzer (FIG. 9). In another example, the synthesis itself can be tuned to create surfaces of metal oxides with the appropriate chemical composition to serve as efficiency proton acceptors and donors, as in the case of solvothermal synthesized SnO₂ nanoparticles which are a composite of bulk crystalline SnO₂ and surface hydroxylated groups.

In an additional embodiment, the composite includes a mixture or combination of mixtures of nanoparticles with ionomers such as a cationic ionomer or an anionic ionomer or polymers such as polyacrylates that serve to enhance the ionic conductivity and/or mechanical adhesion properties of a film comprising the nanoparticles and the ionomer or polymer, and improve the performance of the bipolar membrane in forward or reverse bias.

The catalyst materials forming the composite may be any inorganic, organic, or inorganic-organic hybrid material (i.e. including but not limited to metals, metal oxides, metal phosphides, metal sulfides, etc.). Illustrative metals and metal oxides include rutile and anatase TiO₂, In₂O₃, indium tin oxide (ITO), Sb:SnO₂ (ATO), Sn₂O₃, Ir, IrO₂, Pt, Ru, RuO₂, Pd, Rh, MnO₂, NiO, Al₂O₃, SiO₂, ZnO₂, ZrO₂, Co₂O₃, (and variations thereof, e.g., Co:Fe₂O₃, Fe(OH)₃, Pt—Ir(1:1), Pt—Ru(1:1), Ti, Sn, TiC, SnC, TiB₂, or a combination thereof.

The thickness of the solitary composite catalyst layer may vary. In certain embodiments, the solitary layer may be 1 nm to 2 μm, or 1 nm to 1 μm, and particularly 100 to 400 nm.

In certain embodiments, the catalyst nanoparticles may be included in a single layer nanoparticle film that includes a polymer to bind the nanoparticles, and/or optimize ionic conduction and water transport. This single layer nanoparticle film can be interposed between the AEM and CEM and the resulting subassembly compressed at an elevated temperature to link the polymer, nanoparticles, AEM and CEM. In another embodiment the water dissociation or water recombination catalyst layers can be dispersed into a three-dimensional junction as described, for example, in US 2019/0134570A1 and WO 2017/205458A1 using electrospinning, spraying or other techniques to create and interpenetrating BPM junction.

The inorganic catalyst materials may be disposed on the AEM or CEM surface as continuous layer or as non-continuous layer. If the metal and/or metal oxides are nanoparticles, a layer of nanoparticles may be disposed on the surface wherein the layer includes interstitial spaces between the nanoparticles.

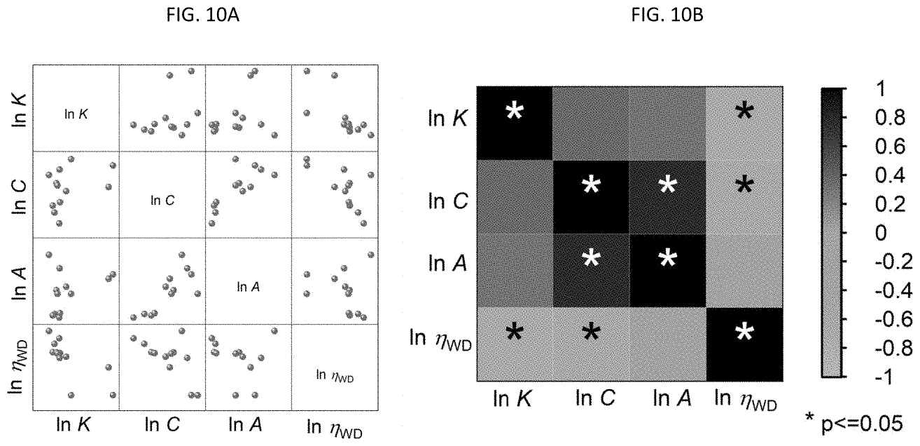

The developed water dissociation catalysts nanoparticle films are guided by the descriptor-based performance prediction model based on the exemplary data. The water dissociation overpotential (η_{wd}@55° C.) required to achieve 500 mA cm⁻² was considered as dependent variable. Twelve commercially available, stable oxide samples were chosen based on their diverse electrical conductivities, specific surface areas, and surface hydroxyl concentrations. To understand the correlation between the chosen reactivity descriptors and overall overpotentials, the scatter plot was generated (FIG. 10A) and Pearson correlation coefficients (PCC) were plotted in FIG. 10B. The features correlated with 0.05 significances are marked with a star (FIG. 10B). A strong correlation was observed between specific surface area, and surface hydroxyl concentration (FIGS. 10A-10B). As the highly intercorrelated reactivity descriptors often lead to redundancy in the input feature, surface hydroxyl concentrations were normalized with specific surface area. These inputs were taken as independent variables to develop a multivariant linear regression (MLR) model using IBM SPSS software.

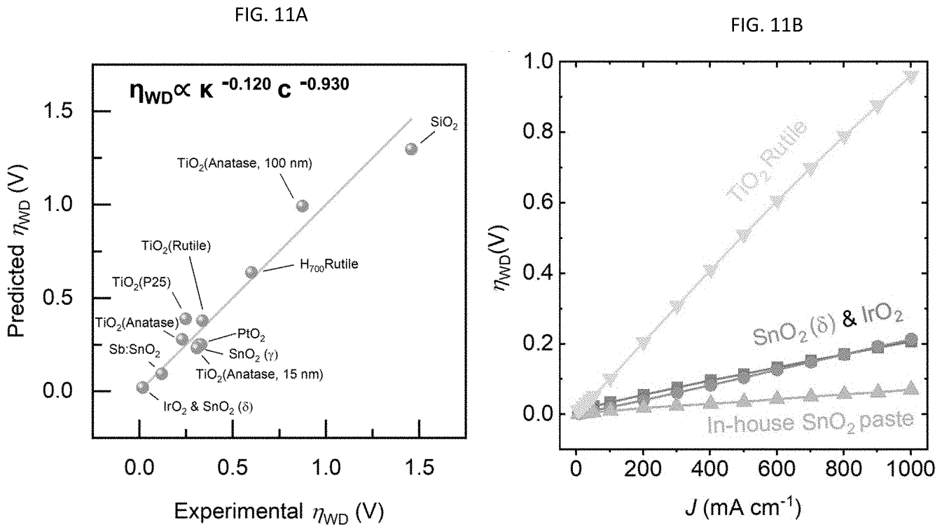

A good fit (R²˜0.97) of predicted and experimental overpotentials points to the robustness of the multivariant linear regression (MLR) model (FIG. 11A). Moreover, this generic model was used satisfactorily to predict and design an in-house SnO₂ paste to demonstrate efficient pure-water BPM catalysis. The SnO₂ paste was synthesized via reflux hydrolysis of SnCl₄·5H₂O. BPM water electrolyzers, optimized with this in-house SnO₂ paste, dissociate pure water at 1 A with a record low η_{wd} (˜70 mV, FIG. 11B). The paste consists of crystalline SnO₂ nanoparticles with size ranges from 2-3 to 20-30 nm in diameter and a high density of hydroxylated surface groups, generating an optimal water dissociation performance in the resulting composite catalyst film.

### Water Recombination Reaction

The structures and methods disclosed herein are also useful for driving the reverse reaction, which is where protons and hydroxide recombine in the bipolar membrane junction, and has broad applicability in fuel cells, carbon dioxide electrolyzers, and other technologies. The reverse reaction is referred to herein as a “recombination” reaction.

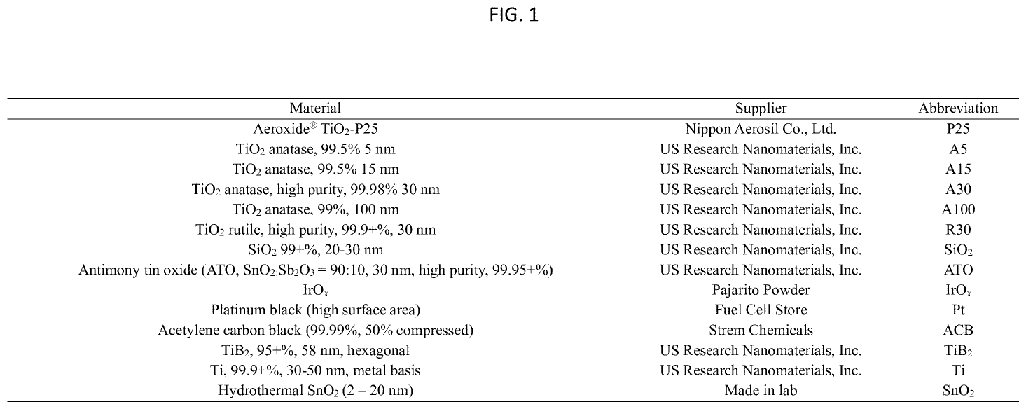

The discovered set of catalyst design principles can be used to create single only or multiple layer catalysts for forward bias water recombination (H⁺+OH⁻→H₂O) reaction, which is the microscopic reverse of water dissociation. More generally, these catalysts can accelerate any reaction involving the recombination of protons with a proton acceptor as the catalyst surface acts as a reservoir of protons. Forward biased bipolar membranes have numerous emerging applications in fuel cells, redox-flow batteries, and CO₂ electrolyzers as examples. Example data showing the high performance of such oxide nanoparticle layers is shown in FIG. 1d where the voltage loss driving the recombination reaction is dramatically reduced using, for example, TiO₂ recombination catalysts over the pristine uncatalyzed bipolar membrane. The recombination catalyst can similarly be uniform in composition or consist of a composite of different materials as is discussed above as well as vary in thickness (1 nm-1000 nm) and particle size (2 nm-200 nm).

### Bipolar Membrane

In certain embodiments, the one or more cation exchange materials of the CEM include at least one of polymers containing protogenic groups including sulfonic, sulfonimide, phosphonic and carboxylic, and their derivatives. For example, the one or more cation exchange polymers include at least one of poly(arylene ether sulfonic acid), poly(phenylsulfone sulfonic acid), poly(phenylene oxide sulfonic acid), poly(arylene sulfonic acid), poly(phosphazene sulfonic acid), sulfonated polybenzimidazole, perfluorosulfonic acid polymers, poly(vinylphosphonic acid), poly(acrylic acid), poly(methacrylic acid) and their copolymers, carboxyphenoxymethylpolysulfone, and their derivatives.

In one embodiment, the perfluorosulfonic acid polymers comprises Nation®, Aquivion®, or their derivatives. In one embodiment, the one or more cation exchange polymers include sulfonated poly(ether ketone) (SPEEK).

In certain embodiments, the one or more anion exchange polymers of the AEM include at least one of polymers containing positive fixed charge groups including quaternary ammonium, guanidinium, phosphonium, and their derivatives.

In one embodiment, the one or more anion exchange polymers include at least one of polymers based on polyarylene or on aliphatic hydrocarbon backbone. In one embodiment, the one or more anion exchange polymers includes quaternized poly(phenylene oxide) (QPPO).

In one embodiment, the anion exchange polymer is a polymer with a styrene backbone with imidazolium groups on the backbone. An example of an imidazolium-functionalized styrene is Sustainion™.

In certain embodiments, the CEM includes a mixture of two or more cation exchange polymers, and the AEM includes a mixture of two or more anion exchange polymers.

Embodiments of the BPM can be used to separate a cathode and an anode, as well as isolate the reactants and/or products associated with the cathode and isolate the reactants and/or products associated with the anode. Embodiments of the BPM can also be configured to manage flux of chemical species from the BPM to the cathode and/or to the anode. For example, the BPM can be used to provide a flux of protons to the cathode and a flux of hydroxide ions to the anode. This may generate an electrochemical device that can eliminate or reduce undesired crossover of chemical product between the cathode and anode. This can also allow the electrochemical device to operate with the anode and cathode at two different stable electrolyte pHs, even under long-term operation.

In some embodiments, the bipolar membrane can include a cation exchange membrane and an anion exchange membrane. In some embodiments, the bipolar membrane can be configured to promote dissociation reactions. In some embodiments, the bipolar membrane further can have a membrane catalyst. In some embodiments, the membrane catalyst is the composite nanoparticle materials disclosed herein. In some embodiments, the anion exchange membrane can be laminated by a cation-exchange polymer film. In some embodiments, the cation-exchange polymer film can be a sulfonated tetrafluoroethylene-based fluoropolymer-copolymer. In some embodiments, the cation-exchange polymer film can be a sulfonated poly(ether ether ketone) polymer. In some embodiments, the cation-exchange polymer film can be a polymeric weak acid, such as poly(acrylic acid). In some embodiments, the cation-exchange film can contain an inorganic cation exchanger such as a clay, a layered transition metal oxide, or graphite oxide, either alone or as a polymer composite. In some embodiments, a surface of the cation exchange membrane can be patterned and/or a surface of the anion exchange membrane can be patterned. In some embodiments, the cathode can include a cathode catalyst. In some embodiments, the cathode catalyst can be platinum, gold, silver, copper, indium, bismuth, lead, tin, tellurium, and/or germanium. In some embodiments, the cathode catalyst can be mixed with a binder, a polymeric electrolyte coating, and/or an ionic liquid. In some embodiments, the anode can include an anode catalyst. In some embodiments, the anode catalyst can be at least one of iridium oxide, ruthenium alloys, mixed oxides of ruthenium containing iridium and/or platinum, mixed metal oxides containing cobalt, nickel, iron, manganese, lanthanum, cerium, copper, nickel borate, cobalt phosphate, NiFeOx.

The electrochemical device can have a cathode with at least one of a liquid-electrolyte style electrode and a gas-diffusion electrode. The electrochemical device can have an anode with at least one of a liquid-electrolyte style electrode and a gas-diffusion electrode. The electrochemical device can have a BPM separating at least a portion of the cathode from at least a portion of the anode. The electrochemical device can have a cathode flow medium comprising carbon or other conducting material. The electrochemical device can have an anode flow medium comprising titanium, steel or other conducting material. The electrochemical device can have a frame configured to hold the cathode flow medium, the cathode, the BPM, the anode, and the anode flow medium together.

In some embodiments, at least one of the cathode flow mediums and the anode flow medium has at least one of a cell inlet and a cell outlet. In some embodiments, the frame has at least one pass-through region corresponding with at least one of the cell inlets and the cell outlet. In some embodiments, the frame seals the electrochemical cell except for at least one pass-through region. In some embodiments, the cathode has a cathode catalyst configured as a reduction catalyst. In some embodiments, the anode has an anode catalyst configured as an oxidation catalyst.

The BPM disclosed herein can be used in electrochemical devices for bipolar membrane electrolysis and fuel cells. Embodiments of the electrochemical device can be configured to generate an output product from an input product and electrical power. The input product can be a gas, a liquid, a solid or combinations thereof e.g. a slurry, gas having solid particulates entrained therein, a liquid having solid particles entrained therein, etc.). The output product can be a gas, a liquid, a solid, or a combination thereof (e.g. a slurry, a gas having solid particulates entrained therein, etc.). In some embodiments, both the input product and the output product include a gas. In some embodiments, the output product can be a reduced chemical product of the input product, an oxidized product of the input product, and/or a combination of both.

In some embodiments the electrochemical device can be configured as an electrolyzer. For example, embodiments of the electrochemical device can be configured to use electric current to drive chemical reactions that may facilitate generating the output product from the input product. In some embodiments, the electrochemical device can be configured as a carbon dioxide (CO₂) electrolyzer. As a non-limiting example, the electrochemical device can be configured to receive carbon dioxide (CO₂) gas as an input product at the cathode. Reactions within the electrochemical device can generate carbon monoxide (CO) or any other hydrocarbon-based reduction product, water (H₂O), and/or hydrogen (H₂) and oxygen (O₂) as an output product. The CO, the H₂O, and/or the H₂ and O₂ may be caused to exit the electrochemical device for capture or further processing. In some embodiments, the H₂O can be caused to self-ionize at the membrane via dissociation to generate protons (H⁺) and hydroxide ions (OH⁻). H₂O can be introduced into the electrochemical device as input product at the anode, cathode, or directly to the membrane. The additional H₂O can be in the form of a liquid or a vapor. The OH⁻ formed by the dissociation of water may be used to react with the anode as electrolyte of the electrochemical device to generate oxygen (O₂), or other oxidized chemical, as additional output product. The H⁺ formed by the dissociation of water may be used to react with the cathode as electrolyte of the electrochemical device to generate hydrogen (H₂), or other reduced chemical, as additional output product. The O₂ and H₂ and/or the other chemical products may be caused to exit the electrochemical device for capture or further processing.

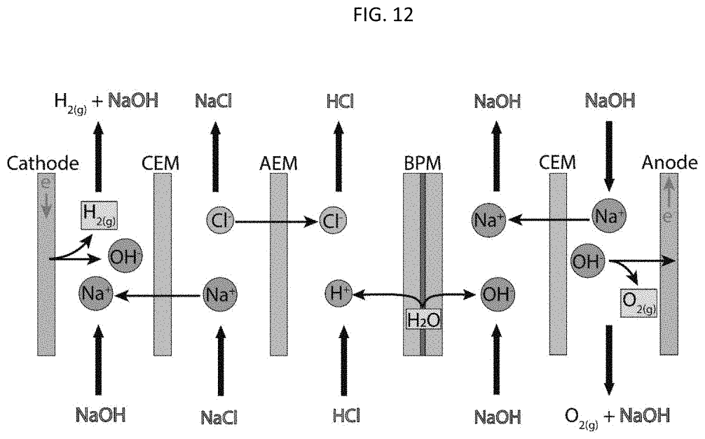

In some embodiments the bipolar membrane including dissociation or recombination catalysts can be used in an electrodialysis system. In these embodiments electrolyte solutions are flowing through channels on either side of the bipolar membrane, as in FIG. 12. As a non-limiting example, the electrodialysis device may have aqueous HCl flowing on the CEM side of the BPM and aqueous NaOH flowing on the AEM side of the BPM. The concentration of the electrolytes is typically between 0.1 and 2 M of the acid, base, or salt in water.

Certain embodiments are described below in the numbered clauses:

1. A bipolar membrane comprising a first member comprising at least one anion exchange material; a second member comprising at least one cation exchange material, wherein the first member and the second member together form an interface junction; and disposed within the interface junction a solitary layer comprising a composite water dissociation catalyst or a composite water recombination catalyst.

2. The bipolar membrane of clause 1, wherein the composite water dissociation catalyst or the composite water recombination catalyst comprises a mixture or combination of at least two different constituents where the difference is in chemical structure.

3. The bipolar membrane of clause 1, wherein the composite water dissociation catalyst or the composite water recombination catalyst comprises a first group of nanoparticles having a first chemical structure and a second group of nanoparticles having a second chemical structure that is different than the first chemical structure.

4. The bipolar membrane of clause 3, wherein the first group of nanoparticles comprises oxide nanoparticles and the second group of nanoparticles comprises electrically conducting nanoparticles.

5. The bipolar membrane of clause 4, wherein the first group of nanoparticles titanium dioxide nanoparticles and the second group of nanoparticles comprises electrically conducting carbon nanoparticles.

6. The bipolar membrane of clause 3, wherein the first group of nanoparticles comprises metallic nanoparticles and the second group of nanoparticles comprises semiconducting nanoparticles.

7. The bipolar membrane of clause 3, wherein the first group of nanoparticles comprises metallic nanoparticles and the second group of nanoparticles comprises oxide nanoparticles.

8. The bipolar membrane of clause 2, wherein the composite water dissociation catalyst comprises cation-doped or anion-doped TiO₂ nanoparticle water dissociation catalysts.

9. The bipolar membrane of clause 3, wherein the first group of nanoparticles comprises titania nanoparticles and the second group of nanoparticles comprises SnO₂ nanoparticles or SiO₂ nanoparticles.

10. The bipolar membrane of clause 1, wherein the composite water dissociation catalyst or the composite water recombination catalyst comprises a mixture or combination of at least two different nanoparticle constituents where the difference is in nanoparticle crystal structure, nanoparticle size, nanoparticle shape and/or nanoparticle density.

11. The bipolar membrane of clause 1, wherein the composite water dissociation catalyst or the composite water recombination catalyst comprises a mixture or combination of at least two different nanoparticle constituents where the difference is in nanoparticle surface chemistry.

12. The bipolar membrane of clause 11, wherein the surface of the nanoparticles are modified with a phosphonic acid, a carboxylate, or an amine.

13. The bipolar membrane of any one of clauses 1 to 12, wherein the catalyst material is TiO₂, In₂O₃, indium tin oxide, Sb:SnO₂, Sn₂O₃, Ir, IrO₂, Pt, Ru, RuO₂, Pd, Rh, MnO₂, NiO, Al₂O₃, SiO₂, ZnO₂, ZrO₂, Co₂O₃, Co:Fe₂O₃, Fe(OH)₃, Pt—Ir(1:1), Pt—Ru(1:1), Ti, Sn, TiC, SnC, TiB₂, or a combination thereof.

14. An electrochemical device comprising the bipolar membrane of any one of clauses 1 to 13.

15. The electrochemical device of clause 14, wherein the bipolar membrane is configured to promote dissociation of water.

16. The electrochemical device of clause 14, wherein the bipolar membrane is configured to promote recombination of water.

17. A method comprising hydrating the bipolar membrane of any one of clauses 1 to 13, and applying a reverse electrochemical bias to the bipolar membrane thereby dissociating water at the bipolar membrane interface junction.

18. A method comprising introducing H⁺ into the at least one cation exchange material of the bipolar membrane of any one of clauses 1 to 13, introducing OH⁻ into the at least one anion exchange material, and applying a forward electrochemical bias to the bipolar membrane thereby recombining water at the bipolar membrane interface junction.

### Examples

The nanoparticle composite films were fabricated from commercial nanoparticle sources, as indicated in FIG. 1, or specifically synthesized with the desired properties. Some nanoparticles, for example composites of SnO₂ and Sn and TiO₂ and Ti were fabricated by partial oxidation of metal nanoparticles in air at temperatures ranging from 200 to 700° C. for between 10 min and 24 hours. Composite nanoparticle film composed of carbon (ACB) and P25 (TiO₂) were fabricated by weighing appropriate weights and combining the nanoparticles in a solvent typically consisting of a mixture of water and isopropyl alcohol. This mixture was sonicated typically for 5 to 60 min to create a water dissociation or recombination catalyst ink that was spray or spin coated onto the CEM or AEM prior to assembly of the BPM.

In view of the many possible embodiments to which the principles of the disclosed invention may be applied, it should be recognized that the illustrated embodiments are only preferred examples of the invention and should not be taken as limiting the scope of the invention.

What is claimed is:

1. A bipolar membrane comprising a first member comprising at least one anion exchange material; a second member comprising at least one cation exchange material, wherein the first member and the second member together form an interface junction; and disposed within the interface junction a solitary layer comprising a composite water dissociation catalyst or a composite water recombination catalyst.

2. The bipolar membrane of claim 1, wherein the composite water dissociation catalyst or the composite water recombination catalyst comprises a mixture or combination of at least two different constituents where the difference is in chemical structure.

3. The bipolar membrane of claim 1, wherein the composite water dissociation catalyst or the composite water recombination catalyst comprises a mixture or combination of at least two different constituents where the difference is in size, shape, chemical composition or surface composition.

4. The bipolar membrane of claim 1, wherein the composite water dissociation catalyst or the composite water recombination catalyst comprises a first group of nanoparticles having a first chemical structure and a second group of nanoparticles having a second chemical structure that is different than the first chemical structure.

5. The bipolar membrane of claim 1, wherein the composite water dissociation catalyst or the composite water recombination catalyst comprises a first group of nanoparticles having a first size, shape, chemical composition or nanoparticle surface composition, and a second group of nanoparticles having a second size, shape, chemical composition or nanoparticle surface composition that is different than the first size, shape, chemical composition or nanoparticle surface composition.

6. The bipolar membrane of claim 5, wherein the first group of nanoparticles comprises oxide nanoparticles and the second group of nanoparticles comprises electrically conducting nanoparticles.

7. The bipolar membrane of claim 6, wherein the first group of nanoparticles titanium dioxide nanoparticles and the second group of nanoparticles comprises electrically conducting carbon nanoparticles.

8. The bipolar membrane of claim 5, wherein the first group of nanoparticles comprises metallic nanoparticles and the second group of nanoparticles comprises semiconducting nanoparticles.

9. The bipolar membrane of claim 5, wherein the first group of nanoparticles comprises metallic nanoparticles and the second group of nanoparticles comprises oxide nanoparticles.

10. The bipolar membrane of claim 2, wherein the solitary layer comprises a composite water dissociation catalyst comprising a cation-doped or anion-doped TiO₂ nanoparticle water dissociation catalyst.

11. The bipolar membrane of claim 2, wherein the solitary layer comprises a composite water dissociation catalyst comprising a cation-doped or anion-doped SnO₂ nanoparticle water dissociation catalyst.

12. The bipolar membrane of claim 4, wherein the first group of nanoparticles comprises titania nanoparticles and the second group of nanoparticles comprises SnO₂ nanoparticles or SiO₂ nanoparticles.

13. The bipolar membrane of claim 1, wherein the composite water dissociation catalyst or the composite water recombination catalyst comprises a mixture or combination of at least two different nanoparticle constituents where the difference is in nanoparticle crystal structure, nanoparticle size, nanoparticle shape and/or nanoparticle density.

14. The bipolar membrane of claim 1, wherein the composite water dissociation catalyst or the composite water recombination catalyst comprises a mixture or combination of at least two different nanoparticle constituents where the difference is in nanoparticle surface chemistry.

15. The bipolar membrane of claim 14, wherein the surface of the nanoparticles is modified with a phosphonic acid, a carboxylate, or an amine.

16. The bipolar membrane of claim 1, wherein the catalyst material is TiO₂, In₂O₃, indium tin oxide, Sb:SnO₂, Sn₂O₃, Ir, IrO₂, Pt, Ru, RuO₂, Pd, Rh, MnO₂, NiO, Al₂O₃, SiO₂, ZnO₂, ZrO₂, Co₂O₃, Co:Fe₂O₃, Fe(OH)₃, Pt—Ir(1:1), Pt—Ru(1:1), Ti, Sn, TiC, SnC, TiB₂, or a combination thereof.

17. An electrochemical device comprising the bipolar membrane of claim 1.

18. The electrochemical device of claim 17, wherein the bipolar membrane is configured to promote dissociation of water.

19. The electrochemical device of claim 17, wherein the bipolar membrane is configured to promote recombination of water.

20. A method comprising hydrating the bipolar membrane of claim 1, and applying a reverse electrochemical bias to the bipolar membrane thereby dissociating water at the bipolar membrane interface junction.

21. A method comprising introducing H⁺ into the at least one cation exchange material of the bipolar membrane of claim 1, introducing OH⁻ into the at least one anion exchange material, and applying a forward electrochemical bias to the bipolar membrane thereby recombining water at the bipolar membrane interface junction.
